(19) United States
(12) Patent Application Publication
(10) Pub. No.: US 2026/0235096 A1
(43) Pub. Date: Aug. 13, 2026

(54) SYSTEM AND RELATED METHOD FOR FUEL INJECTION SYSTEMS

(71) Applicant: Caterpillar Inc., Peoria, IL (US)

(72) Inventors: Dustin K. FEE, Peoria, IL (US); Daniel R. PUCKETT, Peoria, IL (US); Divakar MOHAN, Chennai (IN)

(73) Assignee: Caterpillar Inc., Peoria, IL (US)

(21) Appl. No.: 19/050,460

(22) Filed: Feb. 11, 2025

(51) Int. Cl. F02M 51/06; F02D 41/30

(52) U.S. Cl. CPC F02M 51/061; F02D 41/30

(57) ABSTRACT

A system and related method for fuel injection is described herein. The system may include a fuel injector and a controller. The fuel injector may have an injection valve. The fuel injector may include a solenoid that, when energized, causes the injection valve to move from a resting position to an actuated position. The controller may be configured to generate a command for energizing the solenoid and generate a command for de-energizing the solenoid. The controller may be configured to receive induced current data, via a sensing device, indicative of current generated when the injection valve moves from the actuated position to the resting position. Each data point of the induced current data may represent at least a current amplitude. The controller may be configured to identify a peak current amplitude and determine a return time of the injection valve based on the peak current amplitude.

### TECHNICAL FIELD

The present disclosure relates generally to methods and systems for internal combustion engine systems and, more particularly, to systems and methods for a fuel injection system to determine valve timing.

### BACKGROUND

Internal combustion engines of various types include fuel injectors configured to supply a desired amount of fuel. Engines, including high-output engines, have become increasingly efficient and generate a relatively small amount of undesired emissions. To help achieve these improvements, high-precision fuel injectors are desirable, as precise control over the quantity of injected fuel enables reduced emissions and predictable engine performance.

During some fuel injection events, it is desirable for the fuel injector control unit to determine the amount of time it takes for an injection valve to transition from an injection position to a non-injection position. Information relating to this transition may be useful in determining the health of individual injectors or optimizing control over fuel delivery. Existing systems may lack features for estimating valve return timing of fuel injector valves based on instant parameter values.

An exemplary fuel injection system is described in U.S. Pat. No. 10,156,199 B2 (“the '199 patent”) to Nakano et al. The '199 patent describes electronic control circuitry that can estimate a time interval between energization of a solenoid of an injector and the peak current value of the injector. The peak current value is set as a current value for reliably opening a fuel injection valve of a fuel injector. The electronic control circuitry of the '199 patent may require the peak current value to be known prior to calculating the time at which the current reaches its peak and is unable to determine the peak current value.

The systems and methods of the present disclosure may solve one or more of the problems set forth above and/or other problems in the art. The scope of the current disclosure, however, is defined by the attached claims, and not by the ability to solve any specific problem.

### SUMMARY

Each of the aspects disclosed herein may include one or more features described in connection with any of the other disclosed aspects.

In one aspect, the present disclosure includes a fuel injection system, comprising: a fuel injector and a controller. The fuel injector may have an injection valve movable from a resting position to an actuated position. The fuel injector may also have a solenoid that, when energized, causes the injection valve to move from the resting position to the actuated position. The controller may be configured to: (i) generate a command for energizing the solenoid, (ii) generate a command for de-energizing the solenoid, (iii) receive induced current data indicative of current generated when the injection valve moves from the actuated position to the resting position, the induced current data being received via a sensing device electrically connected to the solenoid, wherein each data point of the induced current data represents at least a current amplitude, (iv) identify a peak current amplitude based on the induced current data, and (v) determine a return time of the injection valve based on the peak current amplitude.

In another aspect, the present disclosure includes a fuel injection system, comprising: a fuel injector and a controller. The fuel injector may have an injection control valve including a resting position and an actuated position. The fuel injector may have a solenoid that, when energized, causes the injection control valve to move from the resting position to the actuated position. The controller may include a first switch, a second switch, and a driver coupled to the first switch and the second switch. The controller may further include a sense resistor. The driver may be configured to energize and de-energize the solenoid via the first switch. The controller may be configured to determine a valve return time of the injection control valve based on voltage across the sense resistor.

In yet another aspect, the present disclosure includes a fuel injection system comprising a fuel injector and a controller. The fuel injector may have a injection control valve and a solenoid. The injection control valve may include a resting position and an actuated position. The solenoid, when energized, may cause the injection control valve to move from the resting position to the actuated position. The controller may be configured to (i) generate a command for energizing the solenoid, (ii) generate a command for de-energizing the solenoid, (iii) receive data indicative of current supplied to the solenoid, the data being measured via a sensing device electrically connected to the solenoid, (iv) determine a peak current value of the current, and (v) determine a valve return time of the injection control valve based on the peak current value.

### BRIEF DESCRIPTION OF THE DRAWINGS

FIG. 1 is a schematic cross-sectional view of an exemplary fuel injection system, according to aspects of the disclosure.

FIG. 2 is an exemplary circuit diagram of an exemplary electronic control module (ECM) of the fuel injection system.

FIG. 3 is a chart showing current (y-axis) from a solenoid of the fuel injection system over time (x-axis) and including first range indicating a valve return time (VRT) and a second range indicating a peak region of the current (PR).

FIG. 4 is a flowchart depicting an exemplary fuel injection method, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

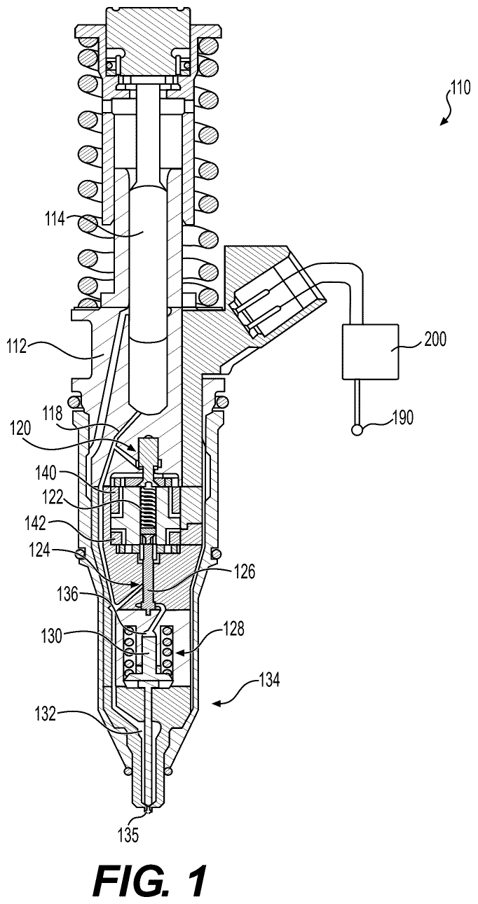

FIG. 1 illustrates an exemplary fuel injection system 110 according to aspects of the present disclosure. Fuel injection system 110 may include a plurality of fuel injectors 112 (one fuel injector 112 shown in FIG. 1), an electronic control module (ECM) 200 in communication with the fuel injectors 112, an internal combustion engine (not shown) in which fuel injectors 112 are installed, and one or more engine condition sensors 190 that monitor aspects of the engine and/or conditions that impact the performance of the engine.

Fuel injector 112 may be a mechanically-actuated electronically-controlled unit injector including a body that houses a cam-driven piston 114, a fuel passage 118 that is configured to receive pressurized fuel, a spill valve 120, a control valve 124, and an injection valve 128. Fuel injector 112 may be in communication with ECM 200 to enable ECM 200 to issue commands for actuating spill valve 120 and control valve 124.

Spill valve 120 may be a normally-open valve including a valve member that is movable between an open state and a closed state. A spring member 122 may bias spill valve 120 toward the open state. When spill valve 120 is open, spill valve 120 may allow fuel to drain and return to a fuel supply system for injectors 112, preventing pressurization of fuel within injector 112. When in the closed state, spill valve 120 may enable pressurization of fuel via piston 114. Spill valve 120 may include a spill valve solenoid 140 for actuating the spill valve member. Spill valve solenoid 140 may be energized in response to commands from ECM 200, the energized state acting to move spill valve 120 to the closed state.

Control valve 124 may be connected between pressurized fuel supply passage 118 and a control chamber 136. Control valve 124 may have a non-injection position, a resting position of valve 124, and an injection position, an actuated position, each position being associated with a control valve member 126. The non-injection position may correspond to a closed state and the injection position may correspond to an opened state. When in the non-injection position, valve member 126 of control valve 124 may enable fluid communication between control chamber 136 and fuel that is pressurized with piston 114, filling chamber 136 with fuel. When control valve member 126 is in the injection position, control chamber 136 may be depressurized by allowing fuel in chamber 136 to drain from fuel injector 112 to the fuel supply system. Spring member 122 may bias control valve 124 to the non-injection position, so that control valve 124 is brought to the injection position with electromagnetic force created by supplying current to control valve solenoid 142. Spring member 122 may form a single element that biases both spill valve 120 and control valve 124.

Following the end of current, energy in solenoid 142 may generate a reduced amount of magnetic force that no longer holds control valve member 126 in the injection position. When valve member 126 returns from the actuated position (injection position) to the resting position (non-injection position), this movement may generate, via induction, a freewheeling current. As will be discussed in further detail below, this freewheeling current may present a current peak that corresponds to the timing at which valve member 126 returns to the resting position (e.g., by contacting a valve seat associated with the non-injection position). The time between end of current and the current peak forms a valve return time (VRT).

Engine condition sensor 190 may include a sensor that detects conditions of the internal combustion engine and/or conditions that affect operation of the internal combustion engine. While a single sensor 190 is shown in FIG. 1, as understood, sensor 190 may represent a plurality of different sensors. Sensors 190 may monitor, for example, engine speed, oil temperature, air flow, air pressure, air temperature (e.g., intake manifold temperature, exhaust manifold temperature), ambient temperature, and/or other conditions, including conditions indicative of engine load. ECM 200 may be configured to receive signals from engine condition sensor 190 (e.g., via wired or wireless communication) and use the information represented by these signals to determine VRT of the control valve 124, as described below.

ECM 200 may be a control module that controls one or more aspects of system 110, including the behavior of the internal combustion engine. ECM 200 may encompass a single control unit that controls multiple aspects of system 110 and, if desired, aspects of a machine in which system 110 is installed. Alternatively, ECM 200 may be achieved by a plurality of separate control units in communication with each other. For example ECM 200 may operate a hydraulics system for actuating an implement of a machine in addition to operating fuel injectors 112 and other aspects of the engine. ECM 200 may be enabled, via programming, to generate commands that control fuel injection events. In particular, ECM 200 may be configured to generate commands for actuating control valve 124 by starting and stopping the supply of energy to solenoid 142. Accordingly, ECM 200 may be configured issue commands to energize and de-energize solenoid 142. ECM 200 may also be configured, via programming, to determine valve return time (VRT) for valve 120 and/or valve 124 of a particular fuel injector 112 of injectors 112 installed in a single engine. ECM 200 may, in response to identifying a particular fuel injector 112 in which the VRT deviates from an expected VRT, generate one or more signals or alerts that identify the particular fuel injector 112 (e.g., by indicating which cylinder the injector 112 is associated with). These signals may be generated on an injector-by-injector basis, enabling individual identification of a plurality of injectors 112 when only a subset of those injectors 112 deviate from the expected VRT. Thus, ECM 200 may be configured to identify defective fuel injectors 112 or fuel injectors 112 operating at diminished capacity based on determined VRTs of the respective injector 112. Additionally or alternatively, ECM 200 may be configured to adjust commands for an injector 112 in which VRT deviates from an expected value, minimizing deviation of future VRT values. These adjustments may include adjusting the time at which current is first applied or the timing of the end of current.

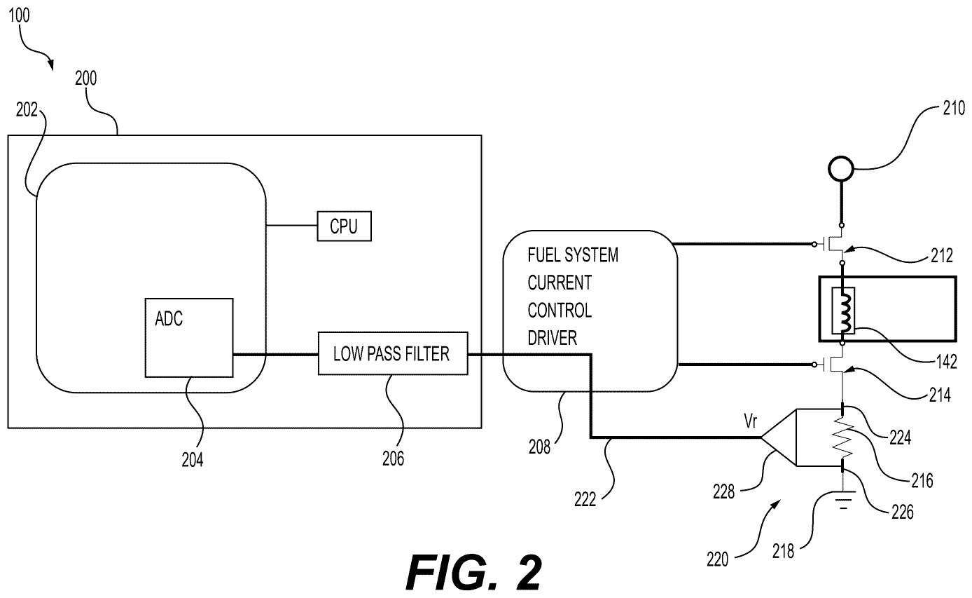

FIG. 2 depicts an exemplary diagram of electrical components connected to ECM 200 in system 110. For clarity, certain components of, and connections to, ECM 200 are omitted to highlight certain features of the present disclosure. For example, although not shown, ECM 200 may include, among other components that would be apparent to those skilled in the art, a memory and a secondary storage device. The memory or secondary storage device associated with ECM 200 may store data and software to allow ECM 200 to perform its functions, including the functions described with respect to method 400, described below. Various other known circuits may be associated with ECM 200, including current monitoring circuitry, signal-conditioning circuitry, communication circuitry, and other appropriate circuitry.

ECM 200 may include one or more devices for accomplishing a task consistent with the present disclosure. For example, as shown in FIG. 2, ECM 200 may include a processor 202, such as a central processing unit (CPU) or a microprocessor. It should be understood that ECM 200 is not limited to one processor 202 and may include a plurality of processors 202. Numerous commercially available microprocessors can be configured to perform the functions of processor 202. ECM 200 may further include an analog-to-digital converter (ADC) 204. For example, ADC 204 may be a component of processor 202. ECM 200 may include a low pass filter 206.

System 110 may include one or more devices for controlling current supplied to fuel injector 112, including solenoid 142 (FIG. 1). For example, system 110 may include a fuel system current control driver 208 (herein “driver”). Driver 208 may include one or more electrical connections to ECM 200 such that driver 208 may send signals to, or receive signals or commands from processor 202, and vice versa. In some aspects, driver 208 may be a component of ECM 200.

Processor 202, via driver 208, may be configured to control one or more switches to permit or inhibit current flow through solenoid 142. In other words, processor 202 may generate commands that cause driver 208 to open or close one or more switches to permit or inhibit current flow through solenoid 142. For example, ECM 200 may include a first, high-side switch 212 and a second, low-side switch 214. Each switch may have an ON state where current is permitted through the respective switch and an OFF state where current is blocked by the respective switch. Each of switches 212, 214 may include a source end (electrically connected to a power source), a drain end (electrically connected to a component configured to receive current and voltage from the switch), and a driver input for receiving commands from driver 208 to transition switches 212, 214 between the ON state and the OFF state. Accordingly, driver 208 may include electrical connections for the driver inputs of each of switches 212, 214 and may control (e.g., permit or inhibit) current through switches 212, 214 by transitioning the switches 212, 214 between the ON state and the OFF state. In some aspects, each of switches 212, 214 may include a transistor such as a field effect transistor (FET), such as a junction field-effect transistor (JFET), metal-oxide-semiconductor field-effect transistor (MOSFET), or other transistors used by those skilled in the art.

As shown in FIG. 2, the source end of first switch 212 may be electrically connected a power source 210 of ECM 200. The drain end of first switch 212 may be electrically connected to an inductor. In the illustrated example, the drain end of first switch 212 is electrically connected to solenoid 142. The driver input of switch 212 may be electrically connected to driver 208. The source end of second switch 214 may be electrically connected an inductor of ECM 200. For example, the source end of second switch 214 may be electrically connected to a second end or portion of solenoid 142. The drain end of second switch 214 may be electrically connected to a sense resistor 216 connected in series with ground 218. The driver input of second switch 214 may be electrically connected to driver 208. In aspects where one or more of switches 212, 214 include a transistor, driver 208 may be electrically connected to and configured to adjust voltages of the gates of the respective transistor to permit or inhibit current flow across the transistor.

ECM 200 may include a sense resistor circuit 220 for determining a voltage (Vr) across sense resistor 216. Sense resistor circuit 220 may include sense resistor 216 and a sense amplifier 228. Sense amplifier 228 may be configured to measure a change in voltage or voltage drop across sense resistor 216. Accordingly, sense amplifier 228 may include a first electrical connection to a first node 224 at a first end of resistor 216 (e.g., between second switch 214 and resistor 216) and a second electrical connection to a second node 226 at a second end of sense resistor 216 (e.g., between resistor 216 and ground 218).

ECM 200, via processor 202, may be configured to monitor or capture current leaving solenoid 142 (e.g., current provided by solenoid 142 to second switch 214) and generate commands to driver 208 to de-energize and energize solenoid 142. Accordingly, as processor 202 controls driver 208 by issuing commands to driver 208, processor 202 may be configured to begin, or issue a command to begin, capturing current data of the current leaving solenoid 142 simultaneously with or subsequently after issuing a command to driver 208 to stop the supply of energy to solenoid 142. For example, ECM 200 may include a line 222 electrically connecting the analog-to-digital converter (ADC) 204 of processor 202 to sense amplifier 228 such that processor 202 may receive Vr from sense amplifier 228. Processor 202 may be further configured to calculate a current through sense resistor 216 based on Vr, as the resistance of resistor 216 is known. As understood, the current through sense resistor 216 may be the same or approximately same value as the current through solenoid 142. As shown in FIG. 2, sense amplifier 228, driver 208, low pass filter 206 of ECM 200 (e.g., to remove noise, such as high frequency noise, from an analog signal received by ADC 204), and ADC 204 of processor 202 may be electrically connected to each other (e.g., via line 222).

Using the sense resistor voltage Vr, ECM 200, via driver 208, may be configured to control current across first switch 212 and second switch 214. During operation, driver 208 may open (OFF state) and close (ON state) switches 212, 214 (e.g., continuously or by repeatedly switching switches 212, 214 between closed and open states) to cyclically transition control valve 124 between the non-injection position and the injection position. For example, to energize solenoid 142, driver 208 may be configured to transition switches 212, 214 to the closed state such that current may flow into and out of solenoid 142. To de-energize solenoid 142, driver 208 may be configured to transition first switch 212 to an open state and maintain second switch 214 in the closed state such that current may flow out of solenoid 142 but not flow into solenoid 142 from first switch 212.

### INDUSTRIAL APPLICABILITY

System 110 may be useful in any internal combustion engine, such as liquid fuel (e.g., diesel fuel, gasoline, etc.) engines, gaseous fuel engines, or dual-fuel engines (engines configured to combust both liquid fuel and gaseous fuel). System 110 may be utilized for generating power in a stationary machine (e.g., a generator or other electricity-generating device) or in a mobile machine (e.g., an earthmoving device, a hauling truck, a drilling machine, etc.). During operation of system 110, current may be supplied to solenoid 140 and 142, resulting in an injection event.

During an injection event, the pressure of fuel within pressurized fuel passage 118 (FIG. 1) may increase when spill valve 120 is closed and a cam drives piston 114 downward. When an injection is desired, ECM 200 may cause the valve member of spill valve 120 and cause valve member 126 of control valve 124 to move from the non-injection position to the injection position.

Current may be supplied to spill valve solenoid 140 and to control valve solenoid 142 as waveforms (e.g., an amplitude of current that changes over time). A spill valve current waveform represents an exemplary amount of current that is supplied to spill valve solenoid 140 for an injection event. A control valve waveform represents an exemplary amount of current supplied to control valve solenoid 142 for an injection event. As used herein, an “injection event” refers to an injection of fuel, directly or indirectly, to a combustion chamber, and includes a main injection, a pilot injection, and/or a post injection. In some aspects, an injection event includes at least a main injection. The injection event may end following a timing at which current is no longer supplied to at least one of solenoids 140 and 142, this timing referred to herein as the “end of current.” As understood, the amount (e.g., amplitude) of current supplied to spill valve solenoid 140 and control valve solenoid 142 may correlate to the amount of force generated to pull and hold the spill valve member and control valve member 126, respectively, in their actuated positions.

During operation of system 110, to inject fuel, driver 208 may cause control valve 124 to transition from the resting state (e.g., non-injection position, closed state) to the actuated state (e.g., injection position, open state), by generating commands that cause first switch 212 to allow current to flow through solenoid 142. Current may be supplied for a period of time, determined by ECM 200, which results in the injection of a desired quantity of fuel. To trigger the end of injection, driver 208 may cause switch 212 to enter an open state. Once current is no longer supplied to solenoid 142 via first switch 212, solenoid 142 may transition from an energized-state to a de-energized-state. After a delay, an increasing amount of current may be supplied to second switch 214 and sense resistor 216 due to motion of valve member 126 from the actuated position to the resting position, the current reaching a peak when valve member 126 first reaches the resting position.

Following injection, the injector 112 may enter a free-wheeling state in which a voltage source is disconnected from solenoid 142 (FIG. 2). While free-wheeling, control valve 124 may transition from the open-state to the closed-state. While transitioning from the open-state to the closed-state, the motion of control valve 124 may generate current. Further, Vr across resistor 216 may increase and decrease proportionally to the current generated by the motion of control valve 124. Accordingly, while solenoid 142 is free-wheeling, driver 208 may be configured to maintain switch 214 in a closed state (ON state) and maintain switch 212 in an open state (OFF state).

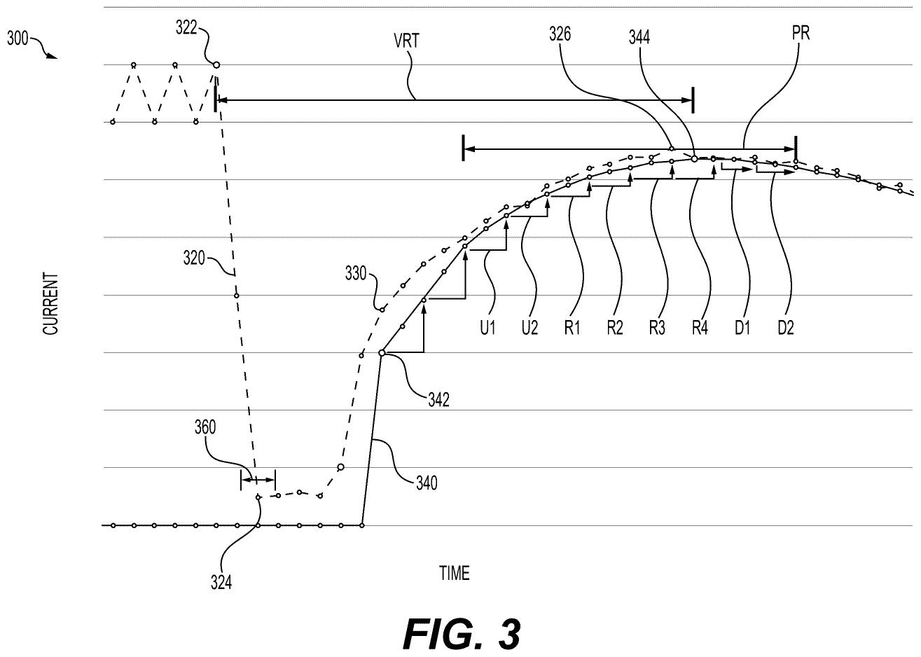

FIG. 3 depicts a chart 300 showing current (y-axis) from solenoid 142 of over time (x-axis). Chart 300 includes measured current values (also referred to herein as “measured line,” “induced current data,” or “feedback data”) 320 and smoothed current values (also referred to herein as “smoothed line”) 340. These values may correspond to the above-describe current waveforms, and may correspond to a waveform for the spill valve or for the control valve.

If desired, raw measurements represented by data points of measured line 320 may be processed to reduce the effect of outliers (e.g., by determining one or more smoothed current values). Smoothed current values may be calculated according to a moving average or other suitable technique. Data points of measured line 320 may indicate the amplitude of current through solenoid 142, as measured via the sense resistor circuit 220, at the point of time indicated by the x-axis. The data points of measured line 320 may be sampled data from sense resistor circuit 220. If desired, this data may have been filtered by low pass filter 206 and converted from an analog signal to a digital signal via ADC 204. Although the data points of measured line 320 and smoothed line 340 are depicted as being connected by lines, it should be understood that these lines connecting data points are illustrative and not necessarily calculated or otherwise determined by ECM 200.

Points of smoothed line 340 in FIG. 3 represent values that are determined by calculating an average (e.g., a moving average) of a plurality of sampled data points of measured line 320. Each data point of smoothed line 340 may be determined by calculating the average of: a sampled data point of line 320, one or more data points of line 320 earlier than the sampled data point, and one or more data points of line 320 that are later than the sampled data point. For example, the data point 342 may be calculated by taking the average of: data point 330 of measured line 320, one or more data points earlier than point 330, and one or more data points later than point 330. The earlier and later data points may be consecutive to (e.g., immediately/directly following) data point 342, and may be consecutive with one another. As shown in FIG. 3, smoothed line 340 may remain at zero or approximately zero until after a stop current command is generated by processor 202 to driver 208 and a sufficient number of data points of line 320 have occurred. In some aspects, smoothed line 340 may remain at zero or approximately zero until after free-wheeling begins or after a sufficient number of earlier data points have occurred.

Measured line 320 includes a stop current data point 322 which indicates the point in time at which driver 208 stops supply of current to solenoid 142 (e.g., after receiving a command from processor 202). After stop current data point 322, current out of solenoid 142, as indicated by current flowing through sense resistor 216 of sense resistor circuit 220, steeply decreases, as shown in FIG. 3, until reaching a near-zero amplitude at point 324.

Using data points of smoothed line 340, ECM 200 may identify a peak region (PR). PR may be configured or set in a manner that ensure that the peak current value of feedback data 320 is located within PR. ECM 200 may set the peak region by determining a slope between data points of line 340. In the illustrated example, ECM 200 determines the slope between pairs of data points that are separated by one or more additional data points. As part of this determination, processor 202 may determine whether a slope between a first data point and a third data point of each consecutive set of three data points is positive or negative.

ECM 200 via processor 202 may identify PR by locating a series of slopes (e.g., consecutive slopes) including: (1) at least one positive slope and (2) two or more negative slopes. In some aspects, PR may include two positive slopes (U1 and U2 in FIG. 3) and two negative slopes (D1 and D2 in FIG. 3). These slopes may be used to define the beginning and the ending of PR, respectively. In the example shown in FIG. 3, eight slopes are shown. These slopes include two positive slopes (U1 and U2), followed by four positive or negative slopes (R1-R4), and two negative slopes (D1 and D2). PR may include a peak average current data point 344 of smoothed line 340 or the peak current data point 326 of measured line 320. After identifying the PR, processor 202 may be configured to locate (e.g., within PR) the peak average current data point 344 of smoothed line 340 by identifying the point at which the positive slope U1-R4 transitions to the negative slope (D1-D2). ECM 200 may identify the current value associated with peak average current data point 344. In some aspects, after identifying the PR, ECM 200 may search a portion of the smoothed line 340 within PR and identify the peak current data point 344 of smoothed line 340 and the current value associated therewith. Similarly, ECM 200 may search a portion of measured line 320 within PR and identify the peak current data point 326 of measured line 320 and the current value associated therewith.

After identifying PR, processor 202 of ECM 200 may determine VRT of control valve 124. Processor 202 may determine VRT by calculating the amount of time between stop current data point 322 and the peak average current data point 344 of smoothed line 340. In some aspects, processor 202 may determine VRT by calculating the amount of time between stop current data point 322 and peak current data point 326.

ECM 200 may generate commands to begin capturing or recording the amount of current leaving solenoid 142 at a timing (e.g., delay) that varies for different fuel injection events. In some aspects, the first sample measured for a particular fuel injection event may be captured at any point of time within a range 360, data point 324 being an example of a first sample within range 360. Varying the timing at which a first measurement occurs may increase the resolution and accuracy of VRT measurements. In cases where it is desirable to achieve greater resolutions of data, ECM 200 may be configured to repeat the steps or commands associated with determining the PR and the VRT in subsequent fuel injection cycles with different timing values (e.g., via the random number generator) within the predetermined delay range 360 until a desired resolution of data is achieved. As processor 202 controls driver 208, processor 202 may determine a delay and then, after this delay, begin capturing the amount of current leaving solenoid 142 after processor 208 issues the stop current command to driver 208.

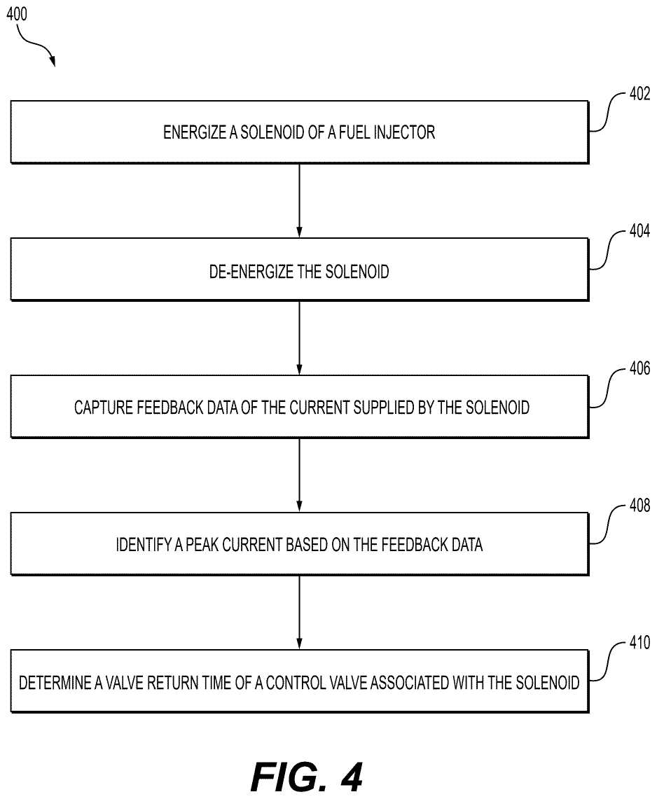

ECM 200 may be configured (e.g., including necessary programs, software, hardware, or algorithms) to execute the steps of method 400 depicted in FIG. 4. Method 400 may include a step 402 of energizing a solenoid (e.g., solenoid 142) with ECM 200, driver 208, switch 212 and power source 210, and a step 404 of de-energizing the solenoid with ECM 200, driver 208, and switch 212. Method 400 may further include a step 406 of beginning capture of feedback data (e.g., measured line 320) of the current supplied by the solenoid with ECM 200. Method 400 may include a step 408 of identifying, with ECM 200, a peak current (e.g., peak average current data point 344 or peak current data point 326) based on the feedback data. Further, method 400 may include a step 410 of determining a valve return time (VRT) of the control valve (e.g., control valve 124) associated with the solenoid. ECM 200 may be configured to repeat the steps of method 400 until a desired resolution is achieved.

The identification of valve return time (VRT) based on peak current may allow a control module to identify healthy operation of injectors 112 and quickly diagnose non-responsive or defective injector valves. Further, use of peak current to determine VRT may help in diagnosing issues with injector valves. The use of data transformation (e.g., moving average calculations) may reduce the influence of inconsistencies or data outliers. ECM 200 may begin data sampling at different times across injection events to generate higher-resolution data.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A fuel injection system, comprising:
a fuel injector, the fuel injector having:
an injection valve movable from a resting position to an actuated position; and
a solenoid that, when energized, causes the injection valve to move from the resting position to the actuated position; and
a controller configured to:
generate a command for energizing the solenoid,
generate a command for de-energizing the solenoid,
receive induced current data indicative of current generated when the injection valve moves from the actuated position to the resting position, the induced current data being received via a sensing device electrically connected to the solenoid, wherein each data point of the induced current data represents at least a current amplitude,
identify a peak current amplitude based on the induced current data, and
determine a return time of the injection valve based on the peak current amplitude.

2. The fuel injection system of claim 1, wherein the controller is configured to sample the induced current data to determine a plurality of current amplitudes including the peak current amplitude.

3. The fuel injection system of claim 1, wherein, after generating the command for de-energizing the solenoid, the controller is further configured to begin capturing induced current data after a delay.

4. The fuel injection system of claim 1, wherein the controller includes a low pass filter, wherein the low pass filter filters a signal from the sensing device.

5. The fuel injection system of claim 1, wherein the controller is configured reduce influence of one or more outlying data points of the induced current data.

6. The fuel injection system of claim 1, wherein the controller is configured to identify the peak current based on: (i) a data point of the induced current data, and (ii) one or more different data points of the induced current data.

7. The fuel injection system of claim 1, wherein the injection valve is a spill valve.

8. The fuel injection system of claim 1, wherein the controller is further configured to determine a peak current region that includes the peak current data point.

9. The fuel injection system of claim 8, wherein the peak current region includes individual data points forming one or more positive slopes in series with at least two negative slopes.

10. The fuel injection system of claim 1, wherein the controller is further configured to determine whether a first data point has a higher amplitude than a second data point of the induced current data, and to determine that a third data point has a lower amplitude than the second data point, the peak current amplitude being determined based on the first data point, the second data point, and the third data point.

11. A fuel injection system, comprising:
a fuel injector, the fuel injector having:
an injection control valve including a resting position and an actuated position; and
a solenoid that, when energized, causes the injection control valve to move from the resting position to the actuated position; and
a controller including:
a first switch;
a second switch;
a driver coupled to the first switch and the second switch; and
a sense resistor;
wherein the driver is configured to energize and de-energize the solenoid via the first switch, and
wherein the controller is configured to determine a valve return time of the injection control valve based on voltage across the sense resistor.

12. The fuel injection system of claim 11, wherein the valve return time is measured across multiple injections by sampling measurements from the sense resistor.

13. The fuel injection system of claim 11, further including an analog to digital converter configured to receive a signal indicating the voltage across the sense resistor.

14. The fuel injection system of claim 11, wherein the first switch, the solenoid, the second switch, and the sense resistor are electrically connected.

15. The fuel injection system of claim 11, further including a low-pass filter, wherein the low-pass filter and a sense amplifier are electrically connected between the controller and the sense resistor.

16. The fuel injection system of claim 11, wherein the driver is configured to energize and de-energize the solenoid at least based on the voltage across the sense resistor.

17. The fuel injection system of claim 11, wherein the controller is configured to compare a determined valve return time to expected valve return time and to adjust current commands or identify an injector fault based on a difference between the valve return time and the expected valve return time.

18. A fuel injection system, comprising:
a fuel injector, the fuel injector having:
an injection control valve including a resting position and an actuated position; and
a solenoid that, when energized, causes the injection control valve to move from the resting position to the actuated position; and
a controller configured to:
generate a command for energizing the solenoid,
generate a command for de-energizing the solenoid,
receive data indicative of current supplied to the solenoid, the data being measured via a sensing device electrically connected to the solenoid,
determine a peak current value of the current, and
determine a valve return time of the injection control valve based on the peak current value.

19. The fuel injection system of claim 18, wherein the sensing device is a sense resistor.

20. The fuel injection system of claim 18, wherein the controller is configured receive data indicative of the current after a delay determined by the controller, wherein the controller is configured to change the delay.
